(19) United States
(12) Patent Application Publication
(10) Pub. No.: US 2006/0015908 A1
(43) Pub. Date: Jan. 19, 2006

(54) Multiple services within a channel-identification in a device

(75) Inventors: Larri Vermola, Turku (FI); Harri Pekonen, Raisio (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/880,838

(22) Filed: Jun. 30, 2004

(51) Int. Cl. H04N 7/20

(52) U.S. Cl. 725/63; 725/68; 725/67; 725/73

(57) ABSTRACT

The invention provides supplemental content related to a service on a receiver device. The supplemental content related to the service is indicted to a user on the receiver device and may be accessed by the user. The receiver device receives and displays the information concerning availability of the supplemental content related to the service. A user may select supplemental content for viewing or listening by selecting a selectable indicator on the receiver device.

### FIELD OF THE INVENTION

Aspects of the present invention relate generally to providing supplemental content related to a service on a receiver device. More specifically, aspects of the present invention concern broadcasting a service and supplemental content relating to the service on a channel to a receiver. The availability of supplemental content related to the service may be indicated to a user on the receiver device.

### BACKGROUND OF THE INVENTION

A variety of mobile computing and receiver devices exist, such as personal digital assistants (PDAs), mobile phones, digital players, and mobile terminals. These mobile computing devices perform various functions specific to the device, and are often able to communicate (via wired or wireless connection) with other devices. A single mobile device may, for example, provide Internet access, maintain a personal calendar, provide mobile telephony, and take digital photographs. These mobile computing devices may also be capable of receiving broadcasting services and multi-media content distributed by such broadcasting services.

Digital Broadcast technologies using standards such as the DVB-T (Digital Video Broadcast-Terrestrial) standard are rapidly expanding in various countries around the world. The DVB-H (Digital Video Broadcast-Handheld) standard is taking the DVB-T standard further by making possible mobile reception of digital broadcasting with handheld devices by reducing power consumption with a time-slicing technology. The DVB transmission technology (also known as IP datacasting) is combined with Internet Protocol (IP). The combination makes it possible to transfer digital content as IP packets. IP datacasting offers the advantage that all existing IP-based digital content such as video streams, web pages, music files, or game software may be distributed over a mobile broadcast.

IP datacasting for mobile devices, as compared to traditional broadcasting, creates a variety of advantages over traditional broadcasting systems. One such advantage enables transmission of additional services over the same channel.

A user of a receiver device, however, should be informed that such additional services are being provided by the channel owner. Also, a user of a receiver device should be able to receive the data in a seamless fashion as a user travels from and to various coverage areas associated with the receiver device. In addition, a user should also be able to select the additional services and be able to return to the original service, if desired. The indication of the additional services should still enable the user to view the primary service on the display of the mobile device without disturbing the user's enjoyment of the primary service.

Therefore, there exists a need in the art for a method and system that informs users of available additional services and allows users to select and view the additional services on their receiver devices.

### SUMMARY OF THE INVENTION

The above mentioned needs in the art are satisfied by aspects of the present invention which are directed to providing supplemental content related to a service on a receiver device. The receiver device receives and indicates information concerning availability of the supplemental content related to the service. A user may select supplemental content for viewing or listening by selecting a selectable indicator on the receiver device. The supplemental content is presented to the user upon selection of the supplemental service by the user.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a block diagram of a wireless communication system in which various aspects of the present invention may be implemented.

FIG. 2 illustrates a block diagram of a receiver device in accordance with an aspect of the present invention.

FIG. 3 illustrates a timeline for transmission of a service and supplemental content information related to the service in accordance with an aspect of the present invention.

FIG. 4 illustrates another timeline showing identification information for the service and supplemental information described in FIG. 3 in accordance with an aspect of the present invention.

FIG. 5 illustrates receipt of supplemental content related to a primary service or program in accordance with another aspect of the present invention.

FIG. 6 illustrates a service and related supplemental content displayed on a receiving device in accordance with an aspect of the present invention.

FIG. 7 illustrates a flow diagram in accordance with one aspect of the present invention.

FIG. 8 illustrates various coverage areas of an exemplary service and supplemental content in accordance with one aspect of the present invention.

FIG. 9 illustrates receipt of a service and supplemental content in various coverage areas in accordance with an aspect of the present invention.

FIG. 10 illustrates the termination of a service due to coverage area and the indication of additional service and supplemental content related to the primary service in accordance with an aspect of the present invention.

FIG. 11 illustrates the selection of supplemental content based on various coverage areas in accordance with an aspect of the present invention.

### DETAILED DESCRIPTION OF THE PREFERRED EMBODIMENTS

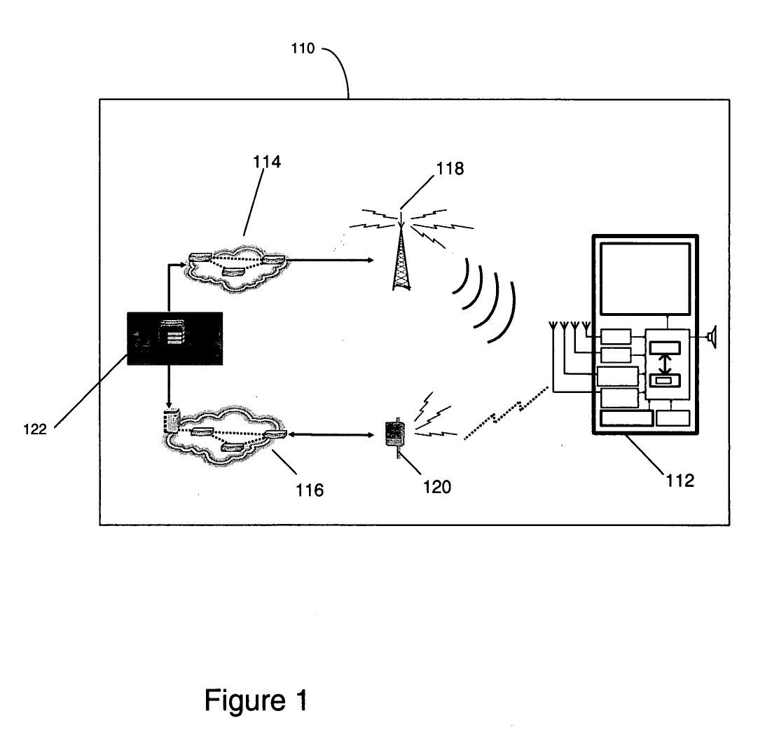

FIG. 1 shows an example of a wireless communication system 110 in which the systems and methods of the present invention may be advantageously employed. One or more network-enabled receiver device 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The receiver device 112 may comprise a digital broadcast receiver device. The service source 122 may be connected to several service providers that may provide their actual program content or information or description of their services and programs to the service source that further provides the content or information to the receiver device 112. The several service providers may include but are not limited to one or more television and/or digital television service providers, AM/FM radio service providers, SMS/MMS push service providers, Internet content or access providers.

The broadcast network 114 may include a radio transmission of IP datacast over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116. The receiver device 112 may also contact the service source 122 through the cellular network 116.

The cellular network 116 may comprise a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, receiver device 112 may comprise a wireless interface configured to send and/or receive digital wireless communications within cellular network 116. The information received by receiver device 112 through the cellular network 116 or broadcast network 114 may include user selection, electronic images, audio clips, and video clips. As part of cellular network 116, one or more base stations (not shown) may support digital communications with receiver device 112 while the receiver device is located within the administrative domain of cellular network 116.

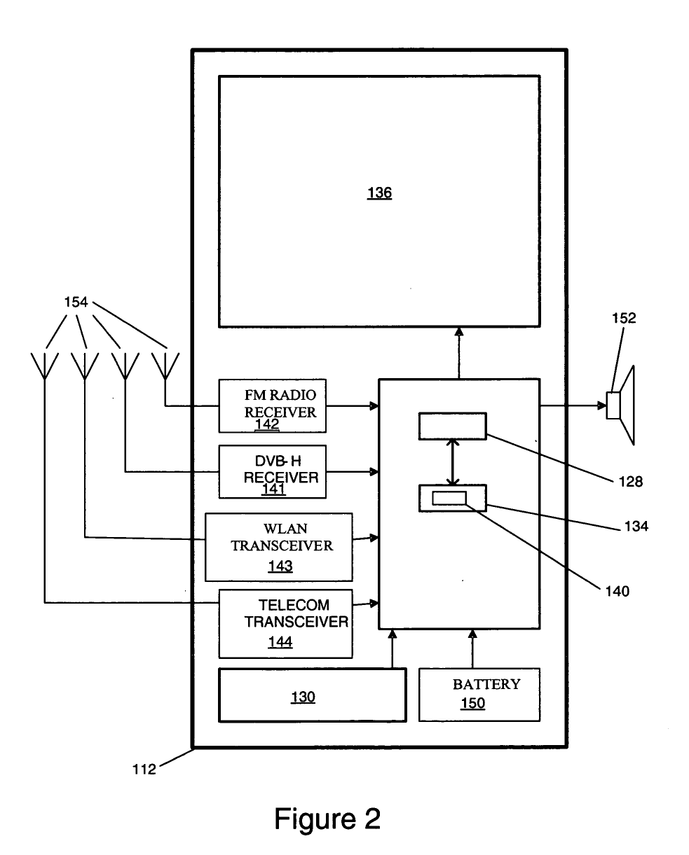

As shown in FIG. 2, receiver device 112 may include processor 128 connected to user interface 130, memory 134 and/or other storage, and display 136. Receiver device 112 may also include battery 150, speaker 152 and antennas 154. User interface 130 may further include a keypad, touch screen, voice interface, or the like. Although not shown, communications interface could include additional wired (e.g., USB) and/or wireless (e.g., BLUETOOTH) interfaces configured to communicate over different communication links.

Computer executable instructions and data used by processor 128 and other components within receiver device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling receiver device 112 to perform various functions. Alternatively, some or all of receiver device 112 computer executable instructions may be embodied in hardware or firmware (not shown).

Receiver device 112 may be configured to receive, decode and process transmissions based on the Digital Video Broadcast (DVB) standard, such as DVB-H, through a specific DVB receiver 141. Additionally, receiver device 112 may also be configured to receive, decode and process transmissions through FM/AM Radio receiver 142, WLAN transceiver 143, and telecommunications transceiver 144.

For example, receiver device 112 may include a DVB or digital television signal receiver 141. In an example of the DVB standard, one DVB 10 Mbit/s transmission may have 200, 50 kbit/s audio program channels or 50, 200 kbit/s video (TV) program channels. In an aspect of the invention, the receiver device 112 may be configured to receive, decode, and process transmission based on the Digital Video Broadcast-Handheld (DVB-H) standard or other DVB standards, such as DVB-Satellite (DVB-S), DVB-Terrestrial (DVB-T) or DVB-Cable (DVB-C). Similarly, other digital transmission formats may alternatively be used to deliver content and information of availabilty of supplemental services, such as ATSC (Advanced Television Systems Committee), NTSC (National Television System Committee), ISDB (Integrated Services Digital Broadcasting), DAB (Digital Audio Broadcasting), DMB (Digital Multimedia Broadcasting) or DIRECTV. Additionally, the digital transmission may be time sliced, such as in DVB-H technology. In this case the receiver device 112 has one or more buffer memories for storing the decoded time sliced transmission before presentation.

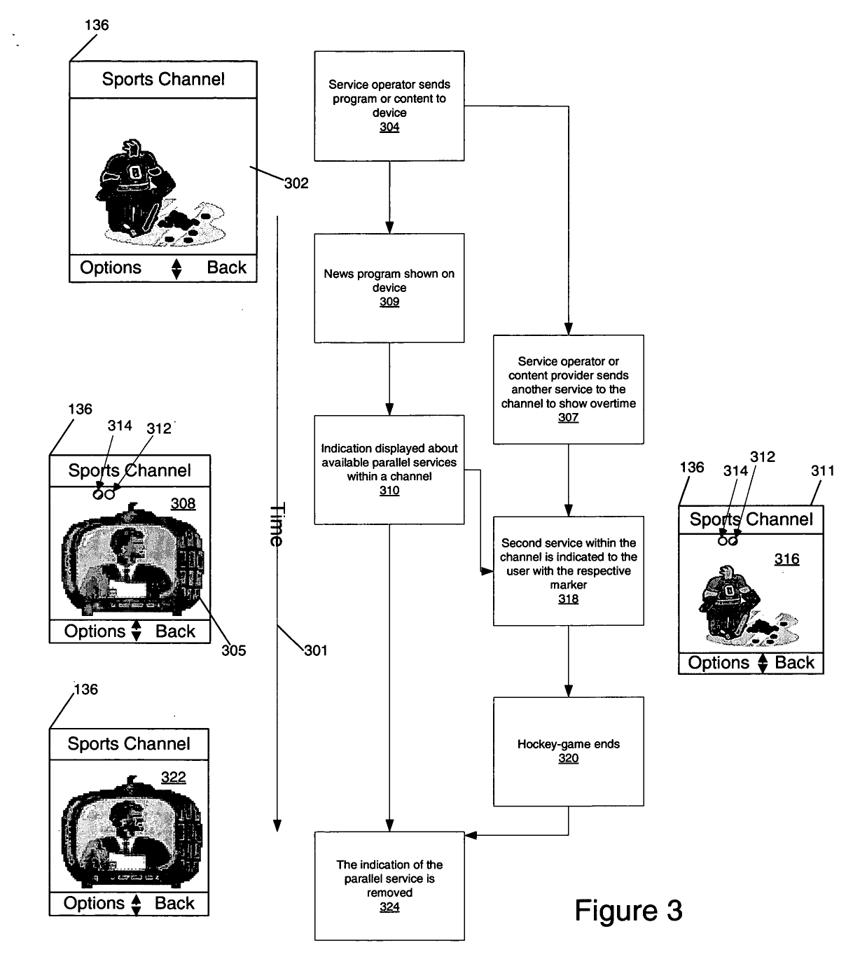

Referring to FIG. 3, a timeline 301 illustrating the providing or transmission of supplemental content related to a service on a receiver device is illustrated. In FIG. 3, a user may be watching a sporting event such as an ice hockey game 302 on a display 136 of a receiver device 112. The ice hockey game 302 may be provided by a service operator over a broadcast network 114 as illustrated in FIG. 3 at step 304. The ice hockey game 302 which may have started at 19:00 hours may have been originally scheduled to be completed at 21:00 hours.

However, due to a tie score at the end of regulation play, the ice hockey game 302 enters a first overtime period. Because of the required overtime period, the ice hockey game 302 will not be completed at the original planned time of 21:00 hours.

The service provider may have a “News” program 305 scheduled to begin at 21:00 hours which may conflict with the continued viewing of the first overtime period of the ice hockey game 302. In an aspect of the invention, the service provider may broadcast “News” program 305 on the same channel at the scheduled time, and broadcast the first overtime period of the ice hockey game 302 as supplemental or parallel content. The supplemental or parallel content which may contain the first overtime period of the ice hockey game 302 may be broadcasted by the service operator as shown in step 307. The “News” program 305 may be shown on display 136 of receiver device 112 as illustrated in screen shot 308 and step 309 of FIG. 3.

The use of supplemental content related to a service, such as a previous or a current service, may enable a service or channel provider to broadcast the scheduled program at the scheduled time and allow those users interested in continuing to watch the ice hockey game 302 to view the first overtime period of the ice hockey game 302 on the same channel as supplemental content or service. For transmission of the supplemental content, the service provider may create a new IP data packet transmission having a unique IP data packet identifier or address and transmit information of availability of the supplemental content.

The receiver device 112 as shown in step 310 may indicate to the user that supplemental content or parallel services are available to be displayed. Selectable indicators such as selectable indicators 312 and 314 illustrated on screen shot 308 may indicate the currently viewed service and the availability of supplemental content. For example, selectable indicator 312 on screen shot 308 may represent that supplemental content such as the first overtime period of the hockey game 302 may be available to be viewed by the user. Similarly, selectable indicator 314 as shown on screen shot 308 may indicate that a particular service is currently being displayed such as “News” program 305. Additionally, a selectable indicator such as selectable indicator 314 may be illuminated (screen shot 308) to further indicate to a user that the current service, such as “News” program 305 is being displayed on display device 136 of receiver unit 112.

As those skilled in the art will realize, selectable indicators may be displayed in numerous different ways on display screen 136 of receiving device 112. For example, selectable indicators may take the form of icons or thumbnails with or without animation. Additionally, the selectable indicators may comprise text strings or only text strings. The icons or thumbnails may have different shapes, widths, heights, colors, intensities, or the like.

A user may select a selectable indicator such as selectable indicator 312 in screen shot 308. When a user selects a selectable indicator, the service represented by the selectable indicator may be displayed on display 136. For example, when selectable indicator 312 of screen shot 308 is selected, the display screen 136 of receiving device 112 displays the first overtime period of the ice hockey game 302 as indicated by screen shot 316. Additionally, as described at step 318 the selectable indicator such as selectable indicator 312 may be illuminated to indicate that the current service, such as the ice hockey game 302 may be currently displayed on display device 136 of receiver unit 112. When ice hockey game 302 ends, i.e. the transmission ends, as described in step 320, the indication of the availability of supplemental content information is removed from the display 136 as shown in screen shot 322 and step 324 of FIG. 3.

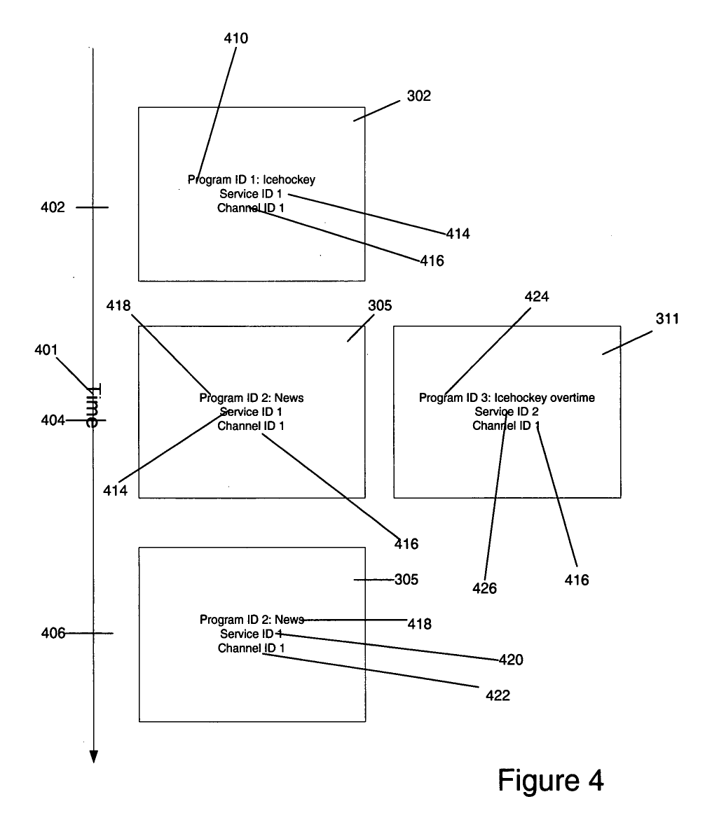

FIG. 4 illustrates information and service parameters, such as identifiers (IDs), that identify services and programs. Similar to FIG. 3, a timeline 401 is provided to illustrate how services and supplemental content may change over a period of time. In FIG. 4, at a time 402 a service or program such as Ice hockey service or program 302 may be broadcasted to a receiver device 112. The ice hockey service or program 302 may comprise a program ID such as Program ID 1 (410) which may define or represent the name or content of a service or program. For example, program ID 1 (410) may contain the name “Icehockey” in order to identify the service or program as a sporting event and in particular an ice hockey game.

A service ID may also be provided to identify a service or program such as Service ID 1 (414) at time 402. Service ID 1 (414) may define supplemental content that may be related to a channel, a service or program. The supplemental content may comprise a supplemental TV content, Internet content; SMS/MMS push service content, FM/AM or digital radio content, content by file delivery, such as games and ring tones, Text-TV or audio content. In addition, a service ID may determine a hierarchy of supplemental content within a service or channel. As illustrated in FIG. 4 at time period 402, only service ID 1 (414) may exist as other supplemental content information may not be available.

A Channel ID may also be provided to identify a program channel such as MTV channel, Eurosport channel, BBC Prime channel, or content downloaded from the device's memory. In the case of content from the device's memory, the content may be transmitted and stored in the device's memory in advance.

In the receiver device 112 a supplemental program information memory may be needed and/or a supplemental program correlation table may be created. The correlation table may include programs and related supplemental program information. This kind of table may be useful if information of availability of supplemental content is received separately from a number of separate and different service providers. Also ad hoc and real time updates of supplemental content may be stored in the correlation table. Supplemental programs may be selected and searched relating to the same Channel ID or any other combination of IDs, or by a Relation ID that describes relations of services directly.

In FIG. 4, at time period 402 a Channel ID such as Channel ID 1 (416) exists. Additional identification information such as an Operator ID may also be used to identify a service provider such as an IP datacasting provider. Any of the identifiers or any combination of the identifiers may be used to relate the services and programs to each other.

In FIG. 4, at time period 404 a service or program such as “News” program 305 may be broadcasted to a receiver device 112. The “News” program 305 may comprise a Program ID such as Program ID 2 (418) which may define or represent the name or content of a service or program. A Service ID such as Service ID 1 (414) and a Channel ID such as Channel ID 1 (416) may also be provided for “News” program 305. Both the Ice hockey program 302 and the “News” program 305 may comprise the same Service ID and Channel ID. The Channel ID may be the same as both the Ice hockey program 302 and the “News” program 305 and may be broadcasted over the same channel. Similarly, the Service ID for both the Ice hockey program 302 and the “News” program 305 may be the same as both represent the first information broadcasted over a channel at their respective time period. Alternatively, the Service ID may be different for every Program ID.

Also at time period 404, supplemental content such as “Icehockey overtime” service or program 311 may be broadcasted to a receiver device 112. The “Icehockey overtime” service or program 311 may comprise a Program ID such as Program ID 3 (424) which may define or represent the name or content of the service or program.

The “Program ID 3: Ice Hockey overtime” may be delivered after the actual game time of the ice hockey game 302 and the delivery will end when the overtime ends. As the actual start and ending time can not be determined in advance, the information about the supplemental content cannot be sent with ESG/EPG in advance, but the information of the delivery of the overtime has to be transmitted after the actual game and before the delivery of the overtime. The transmission may happen through a data stream of an IP datacasting transmission or any other digital TV transmission, through a telecommunications network, WLAN network or digital radio broadcasting network such as DAB (Digital Audio Broadcasting) or using RDS (Radio Data System). The above described transmission networks may be implemented in an IP datacasting transmission system. Information of the supplemental program may be retrieved ad hoc or in real time. Delivery of this information may happen through any transmission network and usually directly from a service provider. A start time may be delivered first and when the need for supplemental information has ended, a stop signal may be delivered. Alternatively, representation of availability of a supplemental program may be removed when the transmission of the supplemental information has ended.

The transmission may contain digital video and/or audio content. The transmission or broadcast may include a plurality of Internet Protocol (IP) data packets relating to a plurality of programs on a plurality of program channels, each of the program channels having associated therewith a data packet stream identifier.

A Service ID such as Service ID 2 (426) and a Channel ID such as Channel ID 1 (416) may also be provided for “Icehockey overtime” program 311. The Channel ID 1(416) may be the same as both the ice hockey program 302 and the “News” program 305 Channel IDs, as the services or programs are broadcasted over the same channel or under the same channel or service name. The Service ID for the “Icehockey overtime” program 311 may be different than the “News” program 305 service ID as the “Icehockey overtime” program 311 may comprise supplemental content to the related program or service “News” program 305 or a channel.

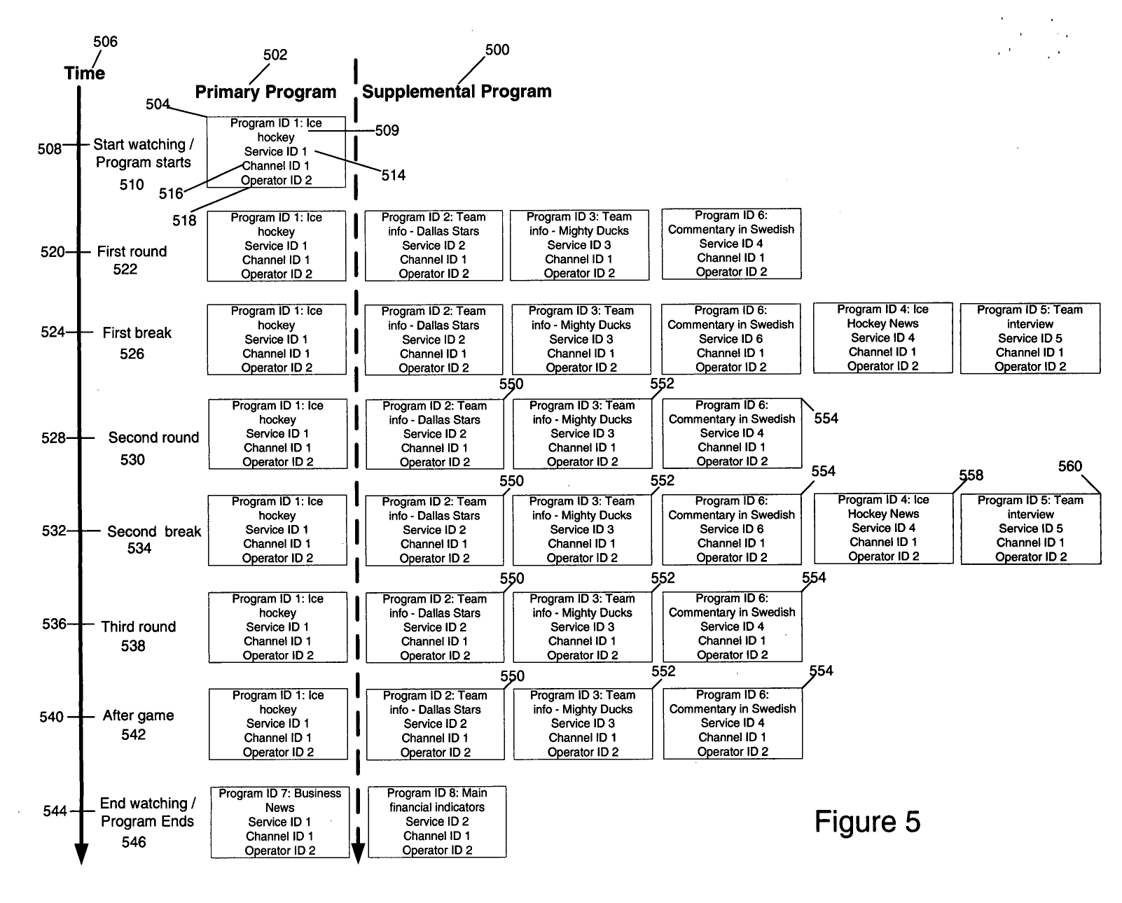

FIG. 5 illustrates the receipt of supplemental content 500 related to a primary service or program 502 in the context of an ice hockey game 504. Those skilled in the art will realize that the use of an ice hockey game 504 is illustrative of just one example of a service or program in which supplemental content may be broadcasted by a service operator to a receiver device over a single channel.

Referring to FIG. 5, a timeline 506 is provided to illustrate how services and supplemental content may change over a period of time. FIG. 5 may also provide information and identifiers that identify services and programs and their relationships to each other. For example, related supplemental content may be determined by a same Channel ID. Alternatively, any of the identifiers (ID) or any combination of them may be used to relate the services and programs to each other.

In FIG. 5 a user may be watching an ice hockey game 504 on a receiver device 112. At a time 508, a service or program such as an Ice hockey program 504 with a Program ID 1 (509) may begin to be broadcasted 510 to a receiver device 112. A Service ID such as Service ID 1(514) and a Channel ID such as Channel ID 1(516) may also be provided for Ice hockey program 504. A Service Operator ID such as Operator ID 2 (518) may also be provided to identify the service operator of Ice hockey program 504. Additionally, the supplemental content may have a Relation ID (not shown) for describing a relationship to other programs and content. The Relation ID may contain any combination of other IDs. For example, a Relation ID such as “Relation ID/Program ID 1; Operator ID 2” may used to describe supplemental content that relates to an Ice hockey game provided by an operator ID 2. Additionally, the supplemental content may have a Time ID (not shown) for describing a time period, i.e. a presentation time, start and/or ending time, for the supplemental service. Alternatively, supplemental content may be related to or determined by a Channel ID and/or by an Operator ID, not only by a Service ID. For example, the display 136 may present services that relate to the same service provider, i.e. the display presents indicators for other services of the selected service provider. In another example, the display 136 may present services that relate to the same service channel, i.e. the display presents indicators for other services of the selected service channel. In the both cases, content of the presented supplemental or related services may not be related to any selected program or service.

During the Ice hockey game 504, a user's IP datacasting receiver device 112 may indicate to the user that selectable supplemental content or programs 500 are available. The supplemental content 500 may be another service related to the same channel or any other content from any other channel. The supplemental content 500 may also contain content from a different service provider, i.e. from another frequency band of an IP datacast transmission. In this case, an Operator ID may describe different service providers.

In addition, the IP datacasting receiver device 112 may obtain information of availability of the supplemental content 500 from an electronic service guide (ESG) or electronic programming guide (EPG), a data stream of IP datacasting, through a telecommunication network, through a WLAN network or through a radio broadcasting network. The Operator ID may describe different service providers and networks. The above described transmission networks may be connected to the IP datacasting transmission system.

The number of available supplemental services 500 may depend on a running time of the program. For example, during Ice hockey game 504 the number of supplemental services 500 may vary from periods/rounds to breaks. For example, as indicated in FIG. 5 at time period 508, primary Ice hockey program 504 may not contain supplemental content. However, during time period 520 or the first period/round 522, the Ice hockey program 504 may comprise three supplemental services 500. Similarly, during a time period 524 or first break 526 the Ice Hockey program 504 may comprise a total of five supplemental services 500.

Those skilled in the art will realize that numerous supplemental services or content may be provided depending on the primary service being broadcasted. Similarly, during the broadcasting of any particular primary service the number of supplemental services may vary. For example, during time periods 528, 536, and 540 representing second round/period 530, third round/period 538, and after game 542, the Ice hockey program 504 may comprise three supplemental services 500. The three supplemental services 500 during time periods 528, 536, and 540 may comprise supplemental content such as “Team info—Dallas stars” (550), “Team info—Mighty Ducks” (552), and “Commentary in Swedish” (554). This may be in contrast to time period 532 or second break 534 which may comprise five supplemental services 500 which may include supplemental content such as “Team info—Dallas stars” (550), “Team info—Mighty Ducks” (552), “Ice Hockey News” (558), “Team Interview” (560), and “Commentary in Swedish” (554).

The supplemental content 500 during each of the time periods may represent different forms of media. For example, the supplemental content “Commentary in Swedish” 554 may comprise an audio service that may be listened to by a user instead of an English language commentary that may be received with the primary service or program. Additionally, the supplemental services or content received through an IP datacasting transmission may be from the same or different IP datacasting service operator than the IP datacasting service operator that provided the primary service.

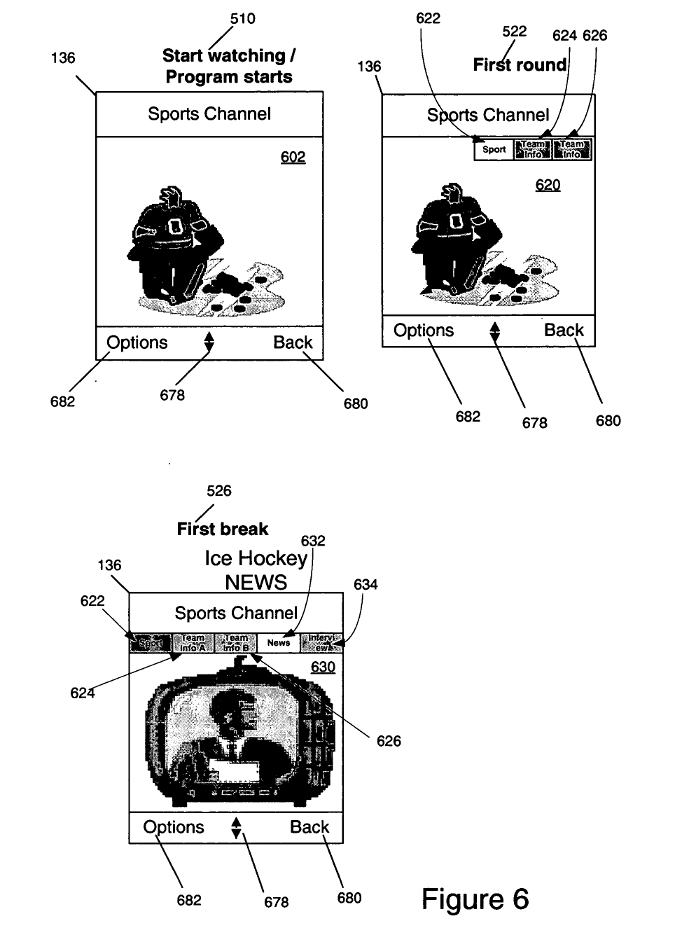

FIG. 6 depicts a representation of Ice hockey program 504 and supplemental content 500 on a receiving device 112. The Ice hockey game 504 may be provided by a service operator over a broadcast network 114. In FIG. 6, the Ice hockey game 504 may be displayed on a display 136 of a receiver device 112 as illustrated in screen shot 602 of FIG. 6. Screen shot 602 may represent time period 508 at the start 510 of the Ice hockey game 504 (FIG. 5).

As illustrated in screen shot 602 at time period 508 (FIG. 5), supplemental content 500 may not be available to a user as indicated by display 136 of receiving device 112. When supplemental content 500 is available to a user, the supplemental content or services 500 may be indicated to a user on display 136 of receiving device 112 as shown in screen shots 620 and 630 of FIG. 6. Screen shot 620 may represent a first round/period 522 at a time period 520. Similarly, screen shot 630 may represent a first break 526 at a time period 524.

Screen shot 620 as shown on display 136 of receiver device 112 may indicate to the user that supplemental content or parallel services are available to be displayed. Selectable indicators such as selectable indicators 622, 624, and 626 illustrated on screen shot 620 may indicate the current service being displayed and the availability of supplemental content. For example, selectable indicators 624 and 626 on screen shot 620 may represent that supplemental content such as “Team info—Dallas stars” (624) and “Team info—Mighty Ducks” (626) may be available for access by the user. Similarly, selectable indicator 622 as shown on screen shot 620 may indicate the primary service or program being displayed on the display 136. Additionally, a selectable indicator such as selectable indicator 622 may be illuminated or displayed with a particular color to indicate that the current service, such as “Sport” may be currently displayed on display device 136 of receiver unit 112.

As those skilled in the art will realize, selectable indicators may be displayed in numerous different ways on display screen 136 of receiving device 112. For example, selectable indicators may take the form of icons or thumbnails with or without animation. Additionally, the selectable indicators may comprise text strings or only text strings. The icons or thumbnails may have different shapes, widths, heights, colors, intensities, or the like. For example, a green icon may depict the current primary service or program, an orange icon may indicate the availability of supplemental services, and a white icon may indicate a selected supplemental service.

A user may select a selectable indicator such as selectable indicator 624 in screen shot 620. When a user selects a selectable indicator, the service represented by the selectable indicator may be displayed on display 136. For example, when selectable indicator 624 of screen shot 620 is selected, the display screen 136 of receiving device 112 may display supplemental content including information such as “Team info—Mighty Ducks.” The selection of various indicators on display 136 may be accomplished by moving a selection box using arrows 678 or similar type keys on receiving device 112. In addition, other selection commands such as page “Back” button 680 or “Options” button 682 may be utilized so that a user can move to additional screens.

Similarly, screen shot 630 representing a first break 526 of Ice hockey program 504 may include similar supplemental content 500 for access by a user. Screen shot 630 may also include additional supplemental content 500 such as “News” (632), “Interview” (634) for access by the user of receiving device 112.

The supplemental content 500 may be transmitted to receiver device 112 over a variety of different radio frequencies and/or networks and/or in a multiplexed manner, e.g. over a single carrier frequency such as in IP datacasting. Receiver device 112 may receive the various channels and programs and display the information to the user based on time scheduling data. Namely, the program content may be delivered in transmission units based on a duration length and time slots. For example, the program may start and may end at the same time interval scheduling based on a clock. Interval steps or duration lengths may be, for example, 30 sec, 5 min, 15 min, 30 min or 60 min and the like. Optionally, a synchronization device, such as synchronizer or a timer, may be used to synchronize transmission of the transmission units from various different channel/program sources before transmission from the program source, because there might be time differences between transmission units on channels originated from different channel/program sources.

The receiver device 112 may comprise one or more transmission or broadcasting receivers (not shown) that may simultaneously receive one or more transmissions and one or more IP transmission or broadcasting decoders (not shown) that may simultaneously decode and buffer one or more transmissions. This may enable fast channel changes within a frequency band and even between channels in different frequency bands. This also may allow for the consumption of one channel and simultaneously storing of another channel in the receiving device. When selecting another service or program while watching a first program, the receiving device 112 may still also decode the first program in the background and give an indication to the user that the first program is still being decoded.

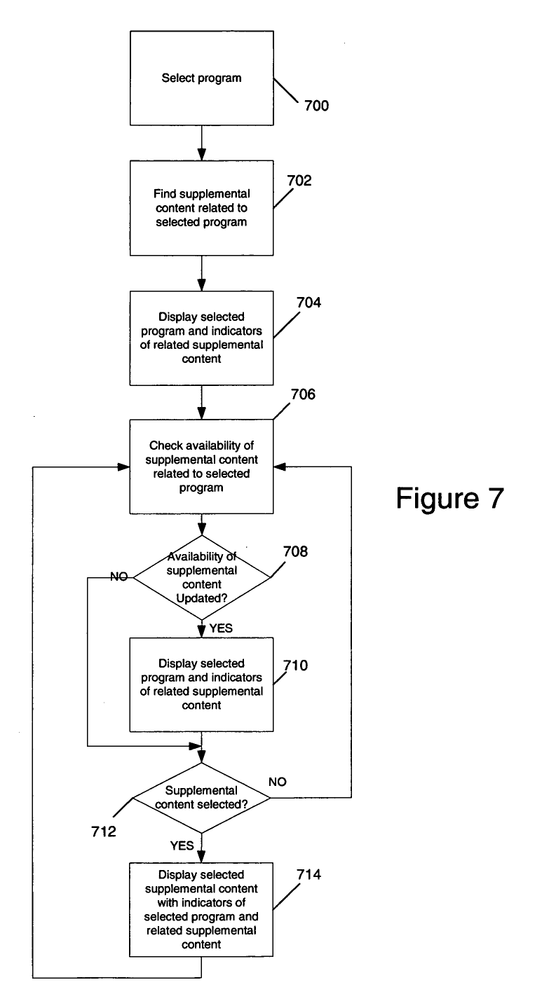

FIG. 7 illustrates a flow diagram in accordance with one aspect of the present invention. In FIG. 7, a user selects a service or program to be accessed at step 700. In response to the user selection, available supplemental content related to the selected service or program may be found or located in step 702. The available supplemental content may be found in the ESG, the supplemental program correlation table. If the correlation table is not available or the ESG does not include supplemental information service parameters, all the available program information may have to be searched by using the service parameters of the selected service. The supplemental content found in step 702 may be displayed in step 704. In particular, a display device may indicate to a user that selectable supplemental content is available related to a primary service.

In step 706, the availability of supplemental information may be checked. The checking may happen in the ESG, or on the supplemental program correlation table or by checking if ad hoc updates for the supplemental services have been received. If additional supplemental information has been updated or made available in step 708, then in step 710 the updated or additional supplemental information may be displayed.

If in step 712, a user selects the supplemental information, then in step 714 the supplemental information is displayed to a user. The display of the supplemental information may include selectable indicators for the selected service and other supplemental services for the selected service. If the displayed supplemental information has its own supplemental service those may also be displayed. If supplemental information is not selected by a user in step 712, then the availability of additional or updated supplemental information is rechecked at some interval or frequency.

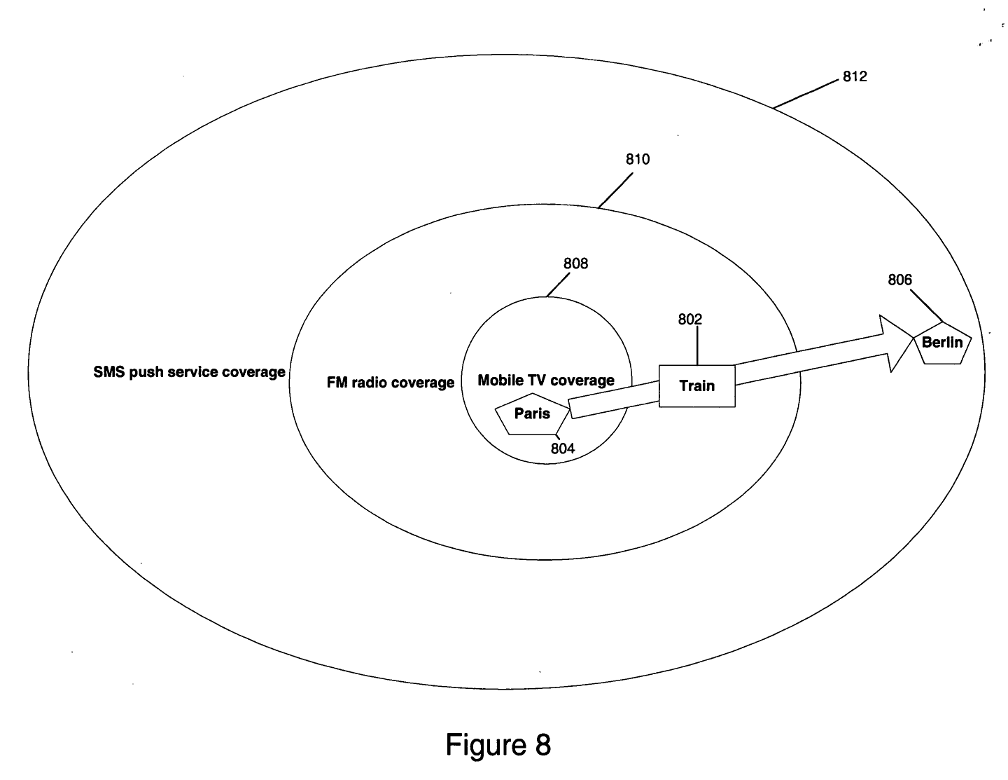

FIG. 8 illustrates various coverage areas in accordance with another aspect of the present invention. As shown in FIG. 8, as a user moves from a first location to a second location, the user may not be able to receive broadcasts of a service on receiver device 112 in a user's selected format. Those skilled in the art will realize that different media services have different coverage areas. For example, as shown in FIG. 8, as a train 802 moves from Paris 804 to Berlin 806, transmission of a service such as an ice hockey game may become unavailable as the user moves out of the coverage area for that particular service. For instance, a mobile television coverage area may be illustrated by area 808, FM radio coverage area by area 810, and SMS push service coverage area by 812. SMS push service coverage area 812 may include statistics concerning the ice hockey game such as updated scores or game highlights.

As a user moves out of and into various coverage areas, a service may not be available. However, supplemental content or other services related to the primary service may be available and offered to the user. For example, in Paris 804 an ice hockey service or program may be available to a user through mobile television coverage area 808, FM/AM radio coverage area 810, and SMS push service coverage area 812; whereas, in Berlin 806 the ice hockey game may only be available through SMS push service coverage area 812. Receiving device 112 may, through a selectable indicator, display to a user the availability of alternative services or supplemental content as the user moves into and out of the various coverage areas. Alternatively, the user may start to use a mobile television service once again when approaching Berlin, if there is another mobile television transmitter in Berlin. The Berlin mobile television transmitter may be operated by the same service provider as in Paris, or it may be a new one. Alternatively, there may be a service handover between mobile television services when moving from one coverage area to a new coverage area. Those skilled in the art will realize that similar scenarios apply to FM/AM services and SMS push services.

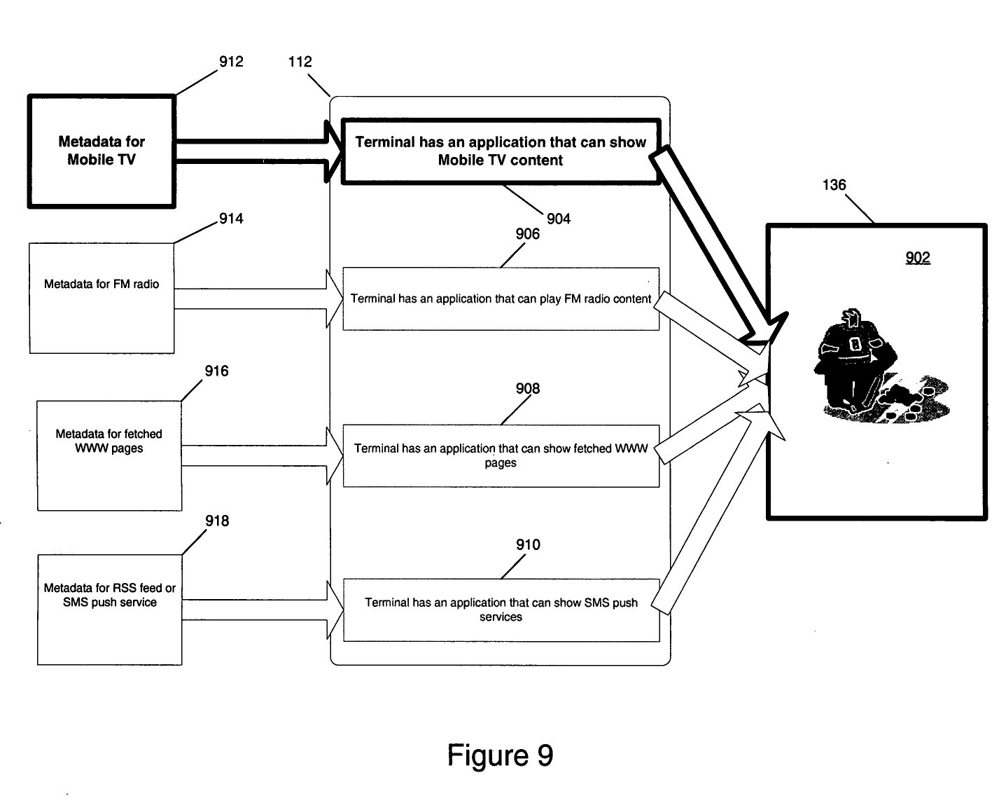

FIG. 9 illustrates receipt of a service and supplemental content in various coverage areas in accordance with an aspect of the present invention. As shown in FIG. 9, a user may be viewing an ice hockey game 902 on a display 136 of a receiver device 112. The receiver device 112 may include applications such as an application to display or play mobile television content 904, FM radio content 906, Internet web pages 908, and SMS push service content 910.

The receiver device 112 may receive information such as metadata. For example, receiver device 112 may receive metadata concerning a mobile television program 912, FM radio program 914, Internet web pages 916, and SMS push service content 918. The metadata may comprise information such as channel information and program information, frequency and IP packet information, date/time information, content information, and descriptor information. Exemplary metadata which may be received by a receiving device 112 from various sources in accordance with aspects of the present invention are illustrated below:

From mobile television broadcast:
Channel: MTV
Program: Music Awards
Frequency: 62 MHz
Date/time: 23.12.2003/19:30-24:00/+2 GMT
Content: annual music awards of MTV Channel
Descriptors: rock, pop, world music, Britney Spears, Madonna

From IPDC television broadcast:
Service provider: Vodafone
Channel: MTV
Program: Music Awards
Frequency: 474 MHz
IP data packet ID: 23874
Date/time: 23.12.2003/19:30-24:00/+2 GMT
Content: annual music awards of MTV Channel
Descriptors: rock, pop, world music, Britney Spears, Madonna

From FM radio broadcast 1:
Channel: KWCM Rock
Program: MTV Music Awards
Date/time: 23.12.2003/20:00-24:00/+2 GMT
Content: music awards of MTV Channel live
Descriptors: rock, pop, world music

From FM radio broadcast 2:
Channel: Rock Radio
Title: MTV Music Awards
Date/time: 2003.12.23; 08:00-11:30 PM
Genre: rock, pop, world music

From Internet broadcast:
Channel: KWCM Rock
Program: MTV Music Awards
IP address: 123.435.434
Date/time: 23.12.2003/20:00-24:00/+2 GMT
Content: music awards of MTV Channel live
Descriptors: rock, pop, world music

From SMS/MMS push service provider:
Service provider: Vodafone
Service: Rock over SMS
Program: MTV Music Awards
Contact: +972 489 9246
Date/time: 23.12.2003/20:00-24:00/+2 GMT
Content: music awards of MTV Channel live
Descriptors: rock, pop, world music

A receiver device 112 may comprise a media guide application that may display service or program information assembled from the received metadata. The service or program information received at the receiver device 112 may be assembled in an electronic service guide and stored in receiver device 112. The receiver device 112 may only display to a user the media formats for which the receiver device 112 has the capability to support. For example, receiver device 112 may detect the services that receiver device 112 is capable of presenting by comparing the services metadata information with receiver device 112 capabilities. Unsupported media guide data may still be available for viewing on receiver device 112, but may not be presented to a user unless requested by the user.

When a service becomes unavailable due to the user moving out of a coverage area, a handover to another service also broadcasting information related to that service or program such as supplemental content may be desirable. The electronic media or service guide may be searched for information regarding new services, channels, and/or supplemental content relating to the primary service. In another aspect of the invention, the electronic media or service guide may be created and/or collected from multiple service or program sources by a service provider at a service source such as service source 122 of FIG. 1 and it may be provided to the receiver device 112 in one set that may be updated frequently or as necessary through any broadcast network 114 or cellular network 116.

When traveling between coverage areas, an indication of poor broadcast network quality or a lost broadcast service may be detected by receiver terminal 112 and displayed. A search for supplemental or new services related to the content of the lost service may be performed by using the content descriptive parameters of the lost service provided by the metadata. For example, if the lost service was an ice hockey game the search may include the same ice hockey game received via a neighboring network, a radio program transmitting the same game, SMS/MSS information push service, an Internet radio transmission, and/or an Internet news service updating and sending highlights of the game.

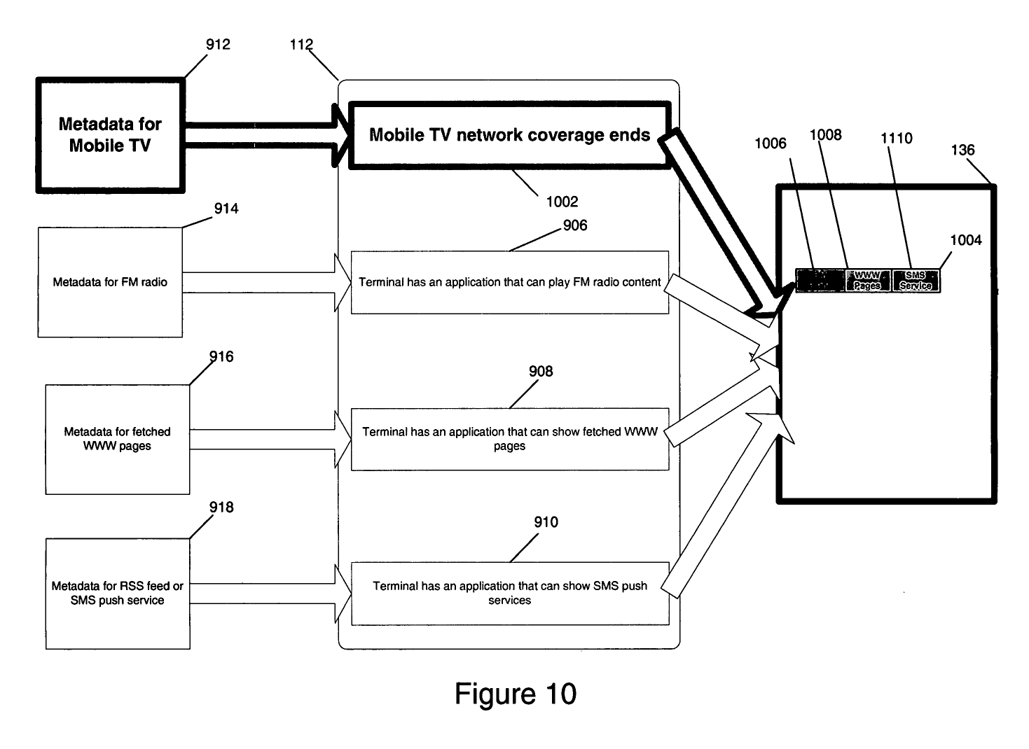

FIG. 10 illustrates the termination of a service or program due to the loss of coverage and the indication of additional services and supplemental content related to the lost service or program. As shown in FIG. 10, mobile television coverage 1002 ends due to the user moving out of the mobile television coverage area 808 (FIG. 8). The receiver device 112 may detect the loss of mobile television coverage before termination of the service and begin searching for new services related to the lost service using the metadata of the lost service or the primary service. An indication on display 136 of receiver terminal 112 may be presented to the user indicating that the service is ending and a selectable list of new related services for user selection may be presented to the user. The user may be offered alternative methods to receive related content of the lost service through FM radio, WWW pages, RSS feed, SMS/MMS push service, or any other media that is available for the user through the terminal.

For example, a selection bar such as selection bar 1004 may present the alternative services or supplemental content which may be provided to the user. For instance, selection bar 1004 may include selection indicators such as FM Radio broadcast selection indicator 1006, Internet Web Pages selection indicator 1008, an SMS push service selection indicator 1110. As those skilled in the art will realize, selection bars or selectable indicators may be displayed in numerous different ways on display screen 136 of receiving device 112. For example, selectable indicators may take the form of icons or thumbnails with or without animation. Additionally, the selectable indicators may comprise text strings or only text strings. The icons or thumbnails may have different shapes, widths, heights, colors, intensities, or the like.

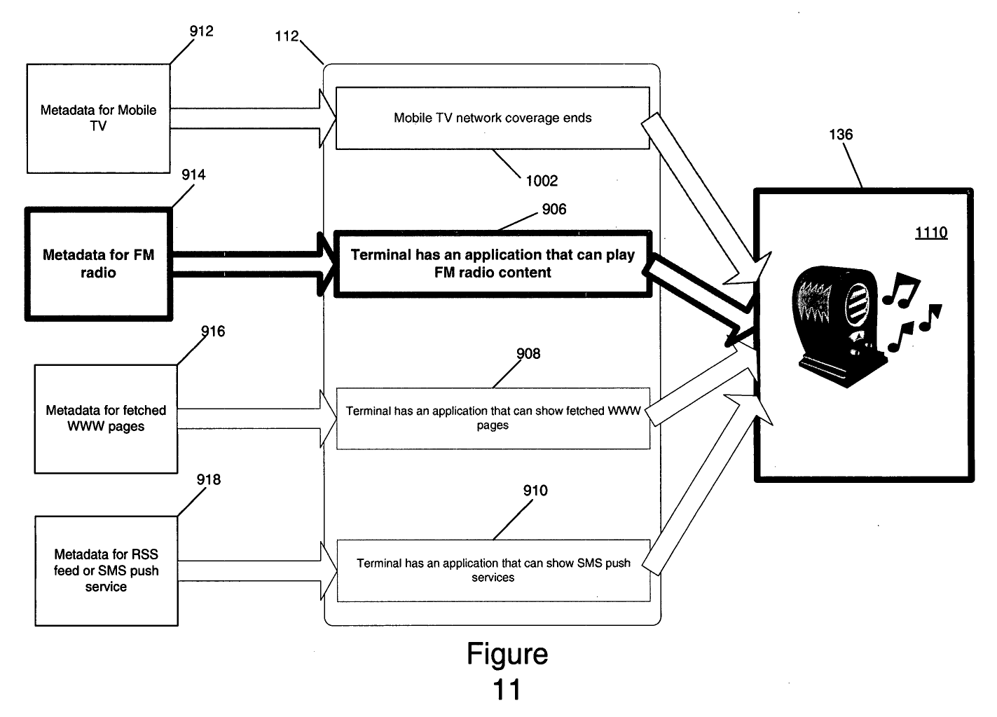

A user may select a selectable indicator such as selectable indicator 1006. When a user selects a selectable indicator, the service or program represented by the selectable indicator may be presented on receiver terminal 112. For example, as illustrated in FIG. 11, when selectable indicator 1006 is selected, receiver device 112 presents an FM radio broadcast of ice hockey game 902 (FIG. 9). As further illustrated in FIG. 11, when a user selects an audio broadcast, such as an FM radio broadcast, an icon or thumbnail representing a radio icon 1110 may be displayed on display 136 of receiving device 112 to indicate that the new service is an audio only broadcast.

As can be appreciated from the preceding description, embodiments of the invention and accompanying figures, the present invention enables a user to select and view supplemental content related to a service or program on a receiver device that indicates to a user the availability of such supplemental content. While illustrative systems and methods as described herein embodying various aspects of the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Also, the invention has been defined using the appended claims; however, these claims are exemplary in that the invention is intended to include the elements and steps described herein in any combination or sub-combination. It will also be appreciated and understood that modifications may be made without departing from the true spirit and scope of the invention.

We claim:

1. A method of providing at least one item of supplemental content related to at least one service on a receiver device, the method comprising the steps of:
(a) receiving information concerning availability of the at least one item of supplemental content related to the at least one service on the receiver device;
(b) displaying at least one indicator to indicate availability of the at least one item of supplemental content related to a selected service;
(c) selecting the at least one item of supplemental content related to the selected service; and
(d) presenting the at least one selected item of supplemental content related to the selected service on the receiver device.

2. The method of claim 1, wherein the at least one item of supplemental content comprises a TV program, a radio program, a SMS/MMS push service, an Internet page, a transmitted software file, and content stored in a memory of the receiver device.

3. The method of claim 1, wherein the at least one service comprises a channel.

4. The method of claim 1, wherein the at least one service comprises a program.

5. The method of claim 4, wherein the program comprises video and audio content.

6. The method of claim 3, wherein the channel comprises a digital video and audio broadcast.

7. The method of claim 1, wherein the selected service is transmitted to the receiver device, the transmission comprising an IP datacasting broadcast, the IP datacasting broadcast received by an IP datacasting receiver device.

8. The method of claim 7, wherein the selected service comprises a digital video and audio broadcast, the digital video and audio broadcast including a plurality of Internet Protocol (IP) data packets relating to a plurality of programs on a plurality of program channels, each of the program channels having associated therewith a data packet stream identifier.

9. The method of claim 1, wherein the at least one item of supplemental content related to the at least one service is received through a wireless telecommunications network.

10. The method of claim 1, wherein the at least one item of supplemental content related to the at least one service is received through a digital television broadcasting network.

11. The method of claim 1, wherein the at least one item of supplemental content related to the at least one service is received through an IP datacasting network.

12. The method of claim 1, wherein the at least one item of supplemental content related to the at least one service is received through a radio broadcasting network.

13. The method of claim 1, wherein the at least one item of supplemental content related to the at least one service is received through a WLAN network.

14. The method of claim 8, wherein the at least one item of supplemental content and the selected service are received through an IP datacasting transmission from a same IP datacasting service operator.

15. The method of claim 8, wherein the at least one item of supplemental content and the selected service are received through an IP datacasting transmission from different IP datacasting service operators.

16. The method of claim 8, wherein the information received concerning the availability of the supplemental content related to the selected service on the IP datacasting receiver device comprises second information obtained through an electronic service guide.

17. The method of claim 1, wherein the information received concerning the availability of the supplemental content related to the at least one service on the receiver device is obtained through an electronic service guide.

18. The method of claim 1, wherein the information received concerning the availability of the supplemental content related to the at least one service on the receiver device is obtained through an IP datacasting.

19. The method of claim 18, wherein the information concerning the availability of the supplemental content is obtained through a data stream of the IP datacasting.

20. The method of claim 1, wherein the information received concerning the availability of the supplemental content related to the at least one service on the receiver device is obtained through an IP datacasting network, a wireless telecommunication network, a radio broadcasting network, or a WLAN network.

21. The method of claim 1, wherein the information received concerning the availability of the supplemental content related to the selected service on the receiver device is substantially simultaneously received with the selected service.

22. The method of claim 1, wherein the information received concerning the availability of the supplemental content related to the selected service on the receiver device is received subsequent to receipt of the service.

23. The method of claim 1, wherein the information received concerning the availability of the supplemental content related to the selected service on the receiver device is received before receipt of the selected service.

24. The method of claim 1, wherein the service and supplemental content comprise a relationship identifier, the relationship identifier indicating the relationship between the service and the supplemental content.

25. The method of claim 24, wherein the relationship identifier comprises a combination of service and channel identifiers.

26. The method of claim 1, further comprising a step between steps (a) and (b) of interconnecting the at least one item of supplemental content with the at least one service.

27. The method of claim 26, further comprising a step between steps (a) and (b) of comparing identifiers of the at least one item of supplemental content with identifiers of the at least one service.

28. The method of claim 1, wherein the at least one item of supplemental content is displayed with a selectable indicator of the selected service.

29. The method of claim 28, wherein the at least one item of supplemental content of the selected service is displayed with selectable indicators of other supplemental content related to the selected service.

30. The method of claim 1, further comprising receiving information concerning availability of the at least one item of supplemental content related to the selected service on the receiver device when moving out of a coverage area of the selected service.

31. The method of claim 1, further comprising displaying the at least one indicator to indicate the availability of the at least one item of supplemental content related to the selected service when the receiver device is capable of receiving the at least one item of supplemental content.

32. The method of claim 1, wherein the information concerning availability of the at least one item of supplemental content is collected in one service guide.

33. A receiver terminal, comprising:
(a) a display;
(b) a memory, the memory storing computer executable instructions;
(c) a communication interface; and
(d) a processor for controlling operation of the receiver terminal, the processor configured to perform the computer executable instructions stored in the memory, the computer executable instructions comprising:
displaying at least one service on the display of the receiver terminal;
receiving information concerning availability of the supplemental content related to the at least one service on the receiver terminal;
displaying an indicator to indicate the availability of the supplemental content related to the at least one service on the display of the receiver terminal;
selecting the supplemental content related to the at least one service; and
presenting the supplemental content related to the at least one service on the display of the receiver terminal.

34. The receiver terminal of claim 33, wherein the at least one service comprises a channel.

35. The receiver terminal of claim 33, wherein the at least one service comprises a program.

36. The receiver terminal of claim 35, wherein the program comprises video and audio content.

37. The receiver terminal of claim 34, wherein the channel comprises a digital video and audio broadcast.

38. The receiver terminal of claim 33, wherein the at least one service is transmitted to the receiver terminal, the transmission comprising an IP datacasting broadcast, the IP datacasting broadcast received by an IP datacasting receiver terminal.

39. The receiver terminal of claim 33, wherein the at least one service comprises a digital video and audio broadcast, the digital video and audio broadcast including a plurality of Internet Protocol (IP) data packets relating to a plurality of programs on a plurality of program channels, each of the program channels having associated therewith a data packet stream identifier.

40. The receiver terminal of claim 33, wherein the supplemental content related to the at least one service is received through a wireless telecommunication network.

41. The receiver terminal of claim 33, wherein the supplemental content and the at least one service are received through an IP datacasting transmission from a same IP datacasting service operator.

42. The receiver terminal of claim 33, wherein the supplemental content and the at least one service are received through an IP datacasting transmission from different IP datacasting service operators.

43. The receiver terminal of claim 38, wherein the information received concerning the availability of the supplemental content related to the at least one service on the IP datacasting receiver terminal comprises information obtained through an electronic service or program guide.

44. The receiver terminal of claim 33, wherein the information received concerning the availability of the supplemental content related to the at least one service on the receiver terminal comprises second information substantially simultaneously received with the at least one service.

45. The receiver terminal of claim 33, wherein the information received concerning the availability of the supplemental content related to the at least one service on the receiver terminal comprises second information that is received subsequent to receipt of the at least one service.

46. The receiver terminal of claim 33, wherein the indicator for indicating the availability of the supplemental content comprises a thumbnail.

47. The receiver terminal of claim 33, wherein the indicator for indicating the availability of the supplemental content comprises a text string.

48. The receiver terminal of claim 33, wherein the receiver terminal comprises a mobile terminal.

49. The receiver terminal of claim 48, wherein the mobile terminal comprises a mobile IP datacasting terminal.

50. The receiver terminal of claim 33, wherein the supplemental content comprises a TV program, a radio program, a SMS/MMS push service, an Internet page, a transmitted software file, and content stored in a memory of the receiver device.

51. A system for providing supplemental content related to a service, the system comprising:
(a) a broadcast network; and
(b) a receiver device for receiving signals broadcast from the broadcast network, the receiver device comprising:
a display;
a memory, the memory storing computer executable instructions;
a communication interface; and
a processor for controlling operation of the receiver device, the processor configured to perform the computer executable instructions stored in the memory, the computer executable instructions comprising:
displaying the service on the display of the receiver device;
receiving information concerning availability of the supplemental content related to the service on the receiver device;
displaying an indicator to indicate the availability of the supplemental content related to the service on the display of the receiver device;
selecting the supplemental content related to the service; and
displaying the supplemental content related to the service on the display of the receiver device.

52. The system of claim 51, wherein the service comprises a channel.

53. The system of claim 51, wherein the service comprises a program.

54. The system of claim 51, wherein the service is transmitted to the receiver device from the broadcast network, the transmission comprising an IP datacasting broadcast, the IP datacasting broadcast received by an IP datacasting receiver device.

55. The system of claim 51, wherein the service comprises a digital video and audio broadcast, the digital video and audio broadcast including a plurality of Internet Protocol (IP) data packets relating to a plurality of programs on a plurality of program channels, each of the program channels having associated therewith a data packet stream identifier.

56. The system of 51, wherein the supplemental content and the service are received through an IP datacasting transmission from different IP datacasting service operators.

57. The system of claim 51, wherein the information received concerning the availability of the supplemental content related to the service on the IP datacasting receiver terminal comprises second information obtained through an electronic service guide.

58. The system of 51, wherein the information received concerning the availability of the supplemental content related to the service on the receiver terminal comprises second information substantially simultaneously received with the service.

59. The system of claim 51, wherein the information received concerning the availability of the supplemental content related to the service on the receiver terminal comprises second information that is received subsequent to receipt of the service.

60. The system of claim 51, wherein the supplemental content related to the service is selected by selecting the indicator.

61. The system of claim 60, wherein the indicator comprises a thumbnail.

62. The system of claim 60, wherein the indicator comprises a text string.

63. The system of claim 51, wherein the receiver device comprises a mobile terminal.

64. The system of claim 63, wherein the mobile terminal comprises a mobile IP datacasting terminal.

65. The system of 51, wherein the supplemental content and the service are received through an IP datacasting transmission from a same IP datacasting service operator.

66. The system of claim 51, wherein the broadcast network comprises an IP datacasting network.

67. The system of claim 51, wherein the broadcast network comprises a radio broadcasting network.

68. The system of claim 51, wherein the broadcast network comprises a WLAN network.

69. The system of claim 51, wherein the information received concerning the availability of the supplemental content related to the service on the receiver device is obtained through an electronic service guide.

70. The system of claim 51, wherein the information received concerning the availability of the supplemental content related to the service on the receiver device is received before receipt of the service.

71. The system of claim 51, wherein the service and supplemental content comprise a relationship identifier, the relationship identifier indicating the relationship between the service and the supplemental content.

72. The system of claim 71, wherein the relationship identifier comprises a combination of service and channel identifiers.

73. The system of claim 51, further comprising receiving information concerning availability of the supplemental content related to the service on the receiver device when moving out of a coverage area of the service.

74. The system of claim 51, further comprising displaying the indicator to indicate the availability of the supplemental content related to the service when the receiver device is capable of receiving the supplemental content.

75. The system of claim 51, wherein the information concerning availability of the supplemental content is collected in one service guide.

76. In a receiver terminal having a graphical user interface including a display and a user interface selection device, a method of providing and selecting from at least one selectable indicator on the display, comprising the steps of:
(a) displaying the at least one selectable indicator to indicate availability of the at least one item of supplemental content related to a selected service;
(c) selecting the at least one item of supplemental content related to the selected service; and
(d) presenting the at least one selected item of supplemental content related to the selected service on the receiver terminal.

77. The receiver terminal of claim 76, wherein the at least one selectable indicator for indicating the availability of the at least one item of supplemental content comprises a thumbnail.

78. The receiver terminal of claim 76, wherein the at least one selectable indicator for indicating the availability of the at least one item of supplemental content comprises a text string.

79. The receiver terminal of claim 76, wherein the receiver terminal comprises a mobile terminal.

80. The receiver terminal of claim 79, wherein the mobile terminal comprises a mobile IP datacasting terminal.

81. The receiver terminal of claim 76, wherein the at least one item of supplemental content comprises a TV program, a radio program, a SMS/MMS push service, an Internet page, a transmitted software file, and content stored in a memory of the receiver terminal.
